(19) United States
(12) Patent Application Publication
(10) Pub. No.: US 2021/0252567 A1
(43) Pub. Date: Aug. 19, 2021

(54) Breakdown Of Solid Waste In Cardboard Manufacturing

(71) Applicant: Ecochem Australia Pty Ltd, Upper Plenty Victoria (AU)

(72) Inventors: Geoffrey Literski, Upper Plenty Victoria (AU); David Campbell, Tullamarine Victoria (AU)

(21) Appl. No.: 17/252,087

(22) PCT Filed: Jun. 17, 2019
(86) PCT No.: PCT/AU2019/050622

§ 371 Date: Dec. 14, 2020

(30) Foreign Application Priority Data
Jun. 15, 2018 (AU) 2018204325

(51) Int. Cl. B09B 3/00; B09B 5/00

(52) U.S. Cl. CPC B09B 3/0016; B09B 5/00

(57) ABSTRACT

The invention provides a method of treating solid waste extracted from a liquid waste stream of a cardboard manufacturing and/or converting facility, comprising the steps of: forming a mixed waste from the solid waste with biological waste; and composting the mixed waste. The invention further provides an apparatus comprising: a mixing system to mix the solid waste with biological waste to form a mixed waste; one or more composting bays to contain one or more corresponding piles of the mixed waste; and aeration system to aerate each of the one or more composting bays from below; and a dosing system to dose one or more types of accelerant onto the composting mixed waste.

### FIELD OF THE INVENTION

The present invention relates to cardboard manufacturing, in particular to a method and apparatus for treating solid waste resulting from the cardboard manufacturing process.

### BACKGROUND OF THE INVENTION

In the cardboard manufacturing industry, construction of corrugated cardboard comprises a process of adhering rolls of paper together using starch glue to construct the corrugated cardboard. During the process, waste water is extracted from the assembly line process and treated before disposal. The solid and liquid waste comprises fragments of paper, starch, acids, solvents. Further, in the conversion process of cardboard into boxes, additional waste water is produced also comprising solvents, oil, greases, powders and paper fragments.

The waste water from the cardboard manufacturing and/or conversion process is typically sent to a treatment plant within the facility where solid matter is extracted from the waste water using flocculants and/or coagulants, enabling solid matter to be skimmed off or settled and precipitated out.

The extracted solid matter is then compressed and disposed of separately as toxic waste, whereby the waste water with the solid matter removed may be disposed of into the environment providing water quality standards have been met.

There is a considerable cost involved in disposing of the solid waste. Such cost may be due to compliance with environmental or other regulations, or may relate to the labour costs and equipment costs associated with disposing solid waste. Additionally, there may be difficulties in determining the physical properties of the solid waste to be treated, including the amount of moisture in the solid waste and in particular the amount of moisture internally held within the solid waste despite an outer region of the waste appearing to be dry.

There is therefore a need to reduce the costs associated with disposal of the solid waste. The present invention seeks to provide methods and systems for the breakdown of solid waste, which will overcome or substantially ameliorate at least one or more of the deficiencies of the prior art, or to at least provide an alternative.

### SUMMARY OF THE INVENTION

In accordance with a first broad aspect of the invention there is provided method of treating solid waste extracted from a liquid waste stream of a cardboard manufacturing and/or converting facility, comprising the steps of:

forming a mixed waste from the solid waste with biological waste; and

composting the mixed waste.

In one embodiment, the step of composting the mixed waste includes adding one or more composting accelerants. Preferably, the one or more composting accelerants include a first and a second bacterial culture.

In one embodiment, the first bacterial culture may include one or more bacterial strains selected for an ability to break down starch and cellulose present in the waste. Preferably, the second bacterial culture may include one or more bacterial strains selected for an ability to break down hydrocarbons present in the waste.

In one embodiment, the first bacterial culture includes one or more of Pseudomonas fluorescens, Pseudomonas putida, Pseudomonas sutzeri, Bacillus subtilis and Bacillus licheniformis.

In one embodiment, the second bacterial culture includes one or more of Arthrobacter globiformis, Serratia plymuthica, Candida rugosa and Thiobacillus thioparus. It is particularly preferred that the second bacterial culture comprises bacterial strains selected for targeting low to high molecular weight hydrocarbons, for reducing hydrocarbon contamination from the waste.

In an embodiment, the adding of the one or more composting accelerants includes providing two or more separate accelerant dosed streams passing through a corresponding separate set of two or more fluid lines. Preferably, the two or more separate accelerant dosed streams provide for separately mixing two or more accelerant with water.

In an embodiment, the adding of one or more composting accelerants includes providing a separate accelerant dosed stream for each of the first bacterial culture and the second bacterial culture, the two separate accelerant dosed streams passing through a corresponding separate set of two or more fluid lines. Preferably, each accelerant dosed stream provides for separately mixing each accelerant with water.

In an embodiment, the adding of composting accelerants includes adding by misting or spraying. The misting or spraying is preferably to an upper surface of the mixed waste. Alternatively, the accelerants may be drip fed or otherwise dispersed onto or within the mixed waste. In a further alternative, the accelerants may be provided in a solid form (e.g. a powder) and sprinkled to the upper surface of the mixed waste, then water may be applied to the upper surface of the waste to activate the bacterial cultures and/or enzymes within the powder.

In one embodiment, the step of forming a mixed waste comprises depositing the solid waste into a mixing apparatus and mechanically breaking up and mixing the solid waste with an initial proportion of the biological waste to form a mechanically processed waste. The step of forming a mixed waste may further include placing the mechanically processed waste into a composting bay.

The step of forming a mixed waste may comprise the step of depositing an additional proportion of the biological waste into the mixing apparatus in layers with the mechanically processed waste.

The initial proportion of the biological waste may be between 10% and 60% by volume of the mechanically processed waste. Preferably the initial proportion of the biological waste is between 10% and 40% by volume of the mechanically processed waste. It is particularly preferred that the initial proportion of the biological waste is between 10% and 30% by volume of the mechanically processed waste.

The additional proportion of the biological waste may be between 10% and 60% of the mixed waste by volume. Preferably, the additional proportion of the biological waste is between 10% and 40% of the mixed waste by volume. It is preferred that the additional proportion of the biological waste is between 10% and 30% of the mixed waste by volume. It is particularly preferred that the additional proportion of the biological waste is between 10% and 25% of the mixed waste by volume.

The biological waste in total may be between 10% and 60% of the mixed waste by volume before the step of composting. Preferably, the biological waste in total is between 10% and 50% of the mixed waste by volume before the step of composting. It is particularly preferred that the biological waste in total is between 20% and 50% of the mixed waste by volume before the step of composting.

In one embodiment, the step of composting includes forming or placing the mixed waste into a sequence of piles within composting bays, each composting bay containing a single pile.

In an embodiment, a composting bay may have dimensions of width and length being about 5 m, and a wall height of about 1.5 m. It is particularly preferred that the biological waste is green waste. Preferably, a composting base comprising biological waste only is first placed into a composting bay before the mixed waste is placed into the bay. Preferably, the composting base comprises about 300 ml of biological waste for the composting bay having the preferred dimensions set out above, the amount being scalable depending on the surface area of the lower surface of the bay.

In an embodiment, the adding of composting accelerants includes providing two or more separate accelerant dosed streams passing through a corresponding separate set of two or more fluid lines. Preferably, the two or more separate accelerant dosed streams provide for separately mixing two or more accelerant with water.

In an embodiment, the adding of composting accelerants includes providing two separate accelerant dosed streams for each of the first bacterial culture and the second bacterial culture, the two separate accelerant dosed streams passing through a corresponding separate set of two or more fluid lines. Preferably, each accelerant dosed stream provides for separately mixing each accelerant with water.

Preferably, the composting accelerants include at least one bacterial culture diluted with water. It is particularly preferred that the step of composting includes adding a first composting accelerant comprising a first bacterial culture, and adding a second composting accelerant comprising a second bacterial culture. Preferably, the at least one bacterial culture is diluted with water. The composting accelerants may include at least one enzyme.

The composting accelerants may include at least one bacterial culture diluted into added water. The at least one bacterial culture may be two bacterial cultures provided in the added water. The composting accelerants may include at least one enzyme provided in the added water.

At least one yeast may be included to assist in creating preferred environmental conditions for the bacterial growth. The at least one yeast may include Yarrowia lipolytica. The at least one enzyme may include one or more of a lipase or an amylase, particularly alpha-amylase. The step of composting may include forming the mixed waste into a pile and adding the composting accelerants by spraying or misting the composting accelerants on to the pile periodically.

In one embodiment, the spraying or misting of accelerants will, fora composting bay, occur for predetermined amount of time, and dispense a predetermined dose of bacteria and water over the composting bay at a predetermined time each evening (to provide improved absorption into the mixed waste). Preferably, the predetermined amount of time is about 1 to 5 minutes, and in particular about 1.5 minutes. Preferably, the predetermined dose of bacteria and water is about 30 to 40 litres, and in particular about 34 litres. The preferred predetermined amount of time and dose are based on a composting bay having the dimensions of a width and length being about 5 m, and a wall height of about 1.5 m. Amounts of time and doses are scalable depending on the dimension of the particular composting bay to receive the accelerants. Preferably, time for spraying or misting is within a few after sunset in the evening (to provide improved absorption into the mixed waste prior to the onset of increased temperatures during the following day).

In one embodiment, the spraying or misting is able to be applied such that it reaches substantially the entire upper surface of the mixed waste.

In one embodiment, the step of compositing includes adding water to the mixed waste to maintain moisture levels. Preferably additional water is deliverable, separately from the accelerant(s). Preferably, the additional water is deliverable via the same fluid line(s) through which the accelerant(s) flow. Preferably, the additional water is deliverable by a programmable control system in response to humidity or temperature readings communicated by one or more sensors located on or around the one or more composting bays.

In one embodiment, the step of composting includes aerating the mixed waste by pumping air from beneath the mixed waste.

In one embodiment, the aerating of the mixed waste includes pumping air through an air supply channel located beneath the mixed waste. Preferably, the air supply channel is located under a lower surface of the composting bay. Preferably, the aerating of the mixed waste includes pumping air through the air supply channel and around a channel cover.

In one embodiment, the air supply channel itself and/or its cover is shaped to have a plurality of raised and lowered portions. It is preferred that the pumped air is able to travel around at least the raised portions of the air supply channel and/or cover.

In one embodiment, a raised portion of the air supply channel and/or cover includes at least one raised element. In use, pumped air is able to flow from the air supply channel and outwardly from and around the raised element. Preferably, in use, there is a plurality of raised elements and pumped air is able to flow from the air supply channel and outwardly from and around each of the raised elements and inwardly towards at least one other raised element. In a preferred form, each raised element includes at least one sloping segment that extends downwardly from an apex and around which air is able to flow. In a particularly preferred form, the raised includes two sloping planar segments that join at the apex of the raised element. Other raised elements are contemplated such as a single sloping segment extending downwardly and forming a knoll like protuberance, in which there is provided plurality of perforations around which air is able to flow.

In an embodiment, the raised portions of the air supply channel and/or cover sit above the lower surface of the composting bay.

In one embodiment, the air supply channel and/or cover is made of a hard and durable material or composite material. It is preferred that the channel is made of steel.

In one embodiment, the air supply channel and/or cover is securable by bolts or other securing means such as pins, screws, etc, to a lower surface of the composting bay.

In one embodiment, in each composting bay there is a plurality of air supply channels, each air supply channel having an air supply channel cover.

In one embodiment, there is provided a screening means to hinder the entrance of waste particles into the air supply channel. Preferably, the screening means comprises a mesh screen. In a particularly preferred form, the screening means comprises a nylon mesh screen which is securable to a lower surface of the composting bay and/or on or around the air supply channel or cover.

In one embodiment, the method further comprises the step of collecting run-off fluid from the step of composting and introducing the run-off fluid into the liquid waste stream of the cardboard manufacturing and/or converting facility.

In one embodiment, the method further comprises the step of collecting run-off fluid from the step of composting and introducing the run-off fluid into the liquid waste stream of the cardboard manufacturing and/or converting facility.

In one embodiment, the biological waste is a green waste. The green waste may be composed of any one or more of wood chips, grass and leaves.

In accordance with a second broad aspect of the invention, there is provided an apparatus for treating solid waste extracted from a liquid waste stream of a cardboard manufacturing and/or converting facility, the apparatus comprising: a mixing system to mix the solid waste with biological waste to form a mixed waste; one or more composting bays to contain one or more corresponding piles of the mixed waste; and aeration system to aerate each of the one or more composting bays from below; and a dosing system to dose one or more types of accelerant onto the composting mixed waste.

In one embodiment, the aeration system and/or composting accelerant dosing system is operable by a programmable control system which is able to be adjusted by an operator, or to self-adjust, depending on changing conditions and requirements of the composting material and environmental conditions such as ambient temperature, humidity, and rainfall in the case of a facility in the open air.

Preferably, the apparatus includes one or more sensors located on or around one or more composting bays for sensing the temperature, humidity, rainfall, or other climatic details and for communicating to the control system to, for example, add more water to the composting bay.

In one embodiment, the apparatus for treating solid waste includes a water supply. Preferably, there are provided one or more fluid line(s) from the water supply that connect with additive tank(s) to enable mixing of the water with bacterial culture and/or enzymes as described above. Alternatively, bacterial culture and/or enzymes can be mixed with water using other mixing means such as adding water directly into the additive tank (i.e. without running a fluid line directly thereto). Alternatively, the bacterial culture and/or enzymes are supplied to the apparatus pre-mixed with water or other liquid. In this application, a composting accelerant is to be understood to refer to bacterial culture(s) and/or enzyme(s), whether or not mixed with water in or outside of the apparatus.

In an embodiment water is mixed in a fluid line that connects to an additive tank through a dosing unit.

In an embodiment, water is mixed in a first fluid line that connects to a first additive tank through a first dosing unit; and water is mixed in a second fluid line that connects to a second additive tank through a second dosing unit. Preferably, the first additive tank is for receiving the first bacterial culture described above, and the second additive tank is for receiving the second bacterial culture described above.

In an embodiment, there is provided flow control means to control the flow of accelerant and/or water into each composting bay. Preferably, the flow control means comprise one or more solenoid and/or stop valves operable by a programmable controller. The flow control means can be differentially operated to differentially spray or mist each bay depending on requirements.

Preferably, two or more separate sets of flow control means are provided for regulating flow of the water from the water supply and/or the accelerant as described above, including into mist or spray applicator supply lines.

In an embodiment, a composting bay is provided with spray or misting applicators in or near to the area where the waste is to be deposited, the spray or misting applicators for application of one or more composting accelerants through spray or misting applicator supply lines. Preferably, the spray or misting applicators are adapted to apply accelerants to reach substantially the entire upper surface of the mixed waste. Preferably, the spray or misting applicator supply lines are located in or around one or more sidewalls and/or a rear wall of the bay. Preferably, the applicators comprise spray and/or misting nozzles placed on the walls along each side of the each composting bay.

Preferably, where a water source is present, one or more nonreturn valves regulate the flow of the water into the fluid lines for mixing the accelerants and the water. The nonreturn valves are for, inter alia, limiting contamination of the water source by the bacterial cultures and/or enzymes.

Preferably, there is provided one or more nonreturn valves to regulate the flow of the accelerant into the spray or misting applicator supply lines of one or more composting bays, respectively. The nonreturn valves are provided to prevent contamination by mixing of different bacterial types within the fluid lines upstream of said valves.

Water without the bacterial or enzymatic accelerants may also be applied to the compost, through the fluid lines, the spray or misting applicator supply lines and the applicators, simply in order to maintain moisture balance or temperature.

In an embodiment, a concrete pad is provided as a base for the composting bay and the pad is slightly inclined towards a spoon drain which collects run-off water from the composting material.

In an embodiment, the aeration system and composting accelerant dosing system is operable by a programmable control system which is able to be adjusted by an operator, or to self-adjust, depending on changing conditions and requirements of the composting material and environmental conditions such as ambient temperature, humidity, and rainfall in the case of a facility in the open air.

Preferably, the aeration system includes a side channel air blower.

Preferably, stop cocks or other air flow control means control the flow of air. Preferably, the air flow control means are controllable by the programmable controller to allow the aeration to only access the composting bays in use.

The features described in relation to one or more aspects of the invention are to be understood as applicable to other aspects of the invention. More generally, combinations of the steps in the method of the invention and/or the features of the system of the invention described elsewhere in this specification, including in the claims, are to be understood as falling within the scope of the disclosure of this specification.

Further details of the apparatus are indicated in the following description of drawings.

### BRIEF DESCRIPTION OF DRAWINGS

Notwithstanding any other forms which may fall within the scope of the present invention, preferred embodiments of the invention will now be described, by way of example only, with reference to the accompanying drawings in which:

FIG. 1 is a perspective view of a composting facility provided by an embodiment of the invention;

FIG. 2 is a plan view of the composting facility of FIG. 1 showing an aeration circuit;

FIG. 3 is a schematic plan view of the composting facility of FIG. 1 showing an accelerant application system;

FIG. 4 is a cross-sectional view of an air supply channel and associated elements of the composting facility of FIG. 1;

FIG. 5 depicts the method steps of a method in accordance with the invention.

FIG. 6 is a block diagram of the processing facility and cardboard manufacturing and/or converting facility and materials flow in relation thereto.

FIG. 7 depicts the method steps of a second method in accordance with the invention.

### DETAILED DESCRIPTION OF EMBODIMENTS

Embodiments of the current invention will now be described.

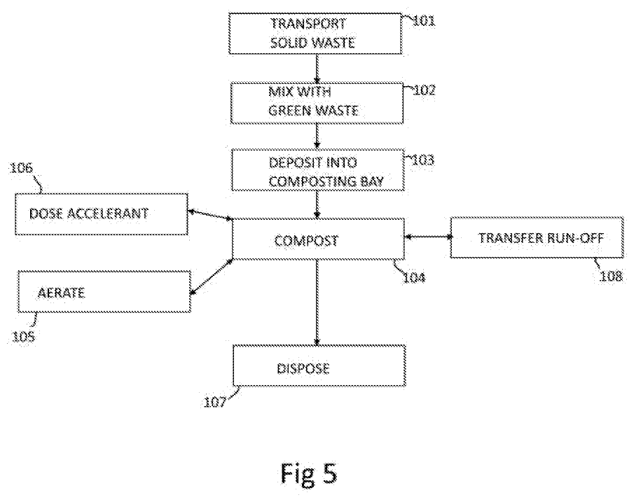

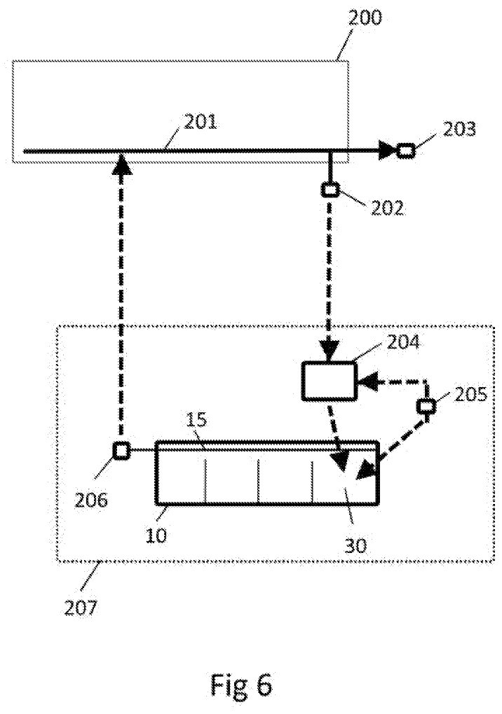

Referring first to FIG. 5 and FIG. 6, method steps and overall design of an embodiment of the invention are set out.

In step 101, solid waste extracted from a liquid waste stream 201 from a cardboard manufacturing and/or converting facility 200 is transported from a solid waste collection point 202 to a solid waste processing facility 207, typically on the same site as the manufacturing and/or converting facility 200 and typically the transfer being done using a forklift or front end loader. A processed liquid waste component from the cardboard manufacturing and/or converting facility 200 exits at egress point 203 into the environment.

In step 102, the transported solid waste is placed into a mixing apparatus being an auger mixer 204 with an initial proportion of biological waste from a biological waste storage point 205. The biological waste in this embodiment comprises green waste in the form of woodchips, grass and leaves typically available from residential council green waste collection bins. The action of an auger in the auger mixer 204 breaks up the lumps of solid waste into smaller more biologically digestible fragments and mixes in the green waste, the solid and biological waste exiting the auger mixer as a mechanically processed waste. The initial portion of green waste in this embodiment is about 20% by volume of the mechanically processed waste.

In step 103, the mechanically processed waste is placed by forklift from the exit of the auger mixer into a composting bay 30 in composting facility 10. Additional green waste from biological waste storage point 205 is also added to the growing composting pile in composting bay 30. Typically, the amount of additional green waste added is again about 20% by volume of the mixed waste, comprising the mechanically processed waste plus additional green waste. Naturally, a person skilled in the art will understand that these proportions can be varied, based on experience gained with particular forms of green waste and solid waste. The final proportion of green waste in the mixed waste may vary between 10% and 60% or more, as specified in various limits above in the summary of the invention.

In step 104, the mechanically processed waste is allowed to compost for a period of time with the assistance of step 105 of aeration and step 106 of composting accelerant application, performed periodically or continuously. The material is composted at least until the composting is judged to have reached a satisfactory conclusion.

The composting accelerant in this embodiment comprises water to maintain an appropriate level of moisture, and different strains of bacteria secreting enzymes suited to digestion of the solid waste and the green waste.

A first bacterial culture comprises bacterial strains selected for an ability to break down starch and cellulose present in the solid waste, namely Pseudomonas fluorescens, Pseudomonas putida, Pseudomonas sutzeri, Bacillus subtilis and Bacillus licheniformis. A variety selected as different strains will flourish in different environmental conditions, changing temperatures and varying pH levels that can impact the performance of individual bacteria. This selection covers a variety of conditions ensuring that at least some of the bacteria applied will flourish and complete the desired task in the expected range of environmental conditions.

A second bacterial culture comprises bacterial strains selected for an ability to break down hydrocarbons present in the solid waste, including one or more of Arthrobacter globiformis, Serratia plymuthica, Candida rugosa and Thiobacillus thioparus.

A yeast Yarrowia lipolytica also included to assist in creating preferred environmental conditions for the bacterial growth.

The composting accelerant of this embodiment further comprises a lipase to break down fats and alpha-amylase to break down starches. Although the bacteria listed above produce their own enzymes to break down fats and starch, these enzymes help start and accelerate the process.

A further advantage of the Bacillus licheniformis bacterial strain is that it produces an enzyme which kills (or outcompetes) both E. coli and Staphylococcus aureus, thereby reducing unpleasant odour and preventing the growth of harmful bacteria.

As each bay 30 is filled, further mechanically processed waste is placed in neighbouring empty bays, each bay typically being in a different state of decomposition. As the volume of compost of material reduces and more room is made, additional material can be added if needed to accommodate demand. The composting process in each bay may last 3-12 months to a satisfactory state of completion whereby a composted material is produced representing a significant economic benefit compared to the negative cost associated with the disposal of the toxic solid waste. The satisfactorily composted material may then be removed and disposed of or sold in step 107.

The economic benefit is seen in one or more of a number of potential factors. A first potential benefit is a reduced volume of the composted material of up to 50% compared with the starting volume of the solid waste. Where disposal is costed on a volume basis, this results in reduced disposal costs. A second potential benefit is a reduced toxicity of the composted material as a result of the decomposition, potentially resulting in the composting material being able to be sold as a plant fertiliser, rather than paying for its disposal as toxic waste.

In step 108, during composting run-off liquid drains into spoon drain 15 and on to run-off liquid collection point 206 which may then be transferred by pipe or periodical forklift trips to liquid waste stream 201. An advantage of this step, apart from disposing of the run-off liquid, is that the bacteria used or present in the composting process is introduced into the liquid waste stream of the cardboard manufacturing and/or converting facility, which then results in the bacteria being partly already present in the solid waste extracted therefrom.

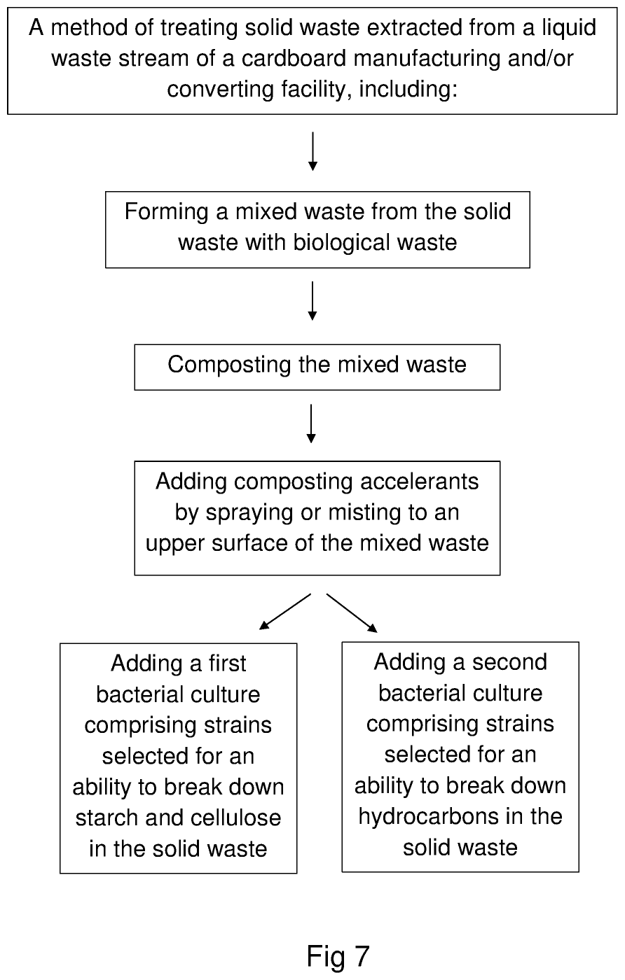

In relation to FIG. 7, there is depicted a further method in accordance with the invention, the method treating solid waste extracted from a liquid waste stream of a cardboard manufacturing and/or converting facility of the method of the invention, in accordance with a preferred method of the invention. The method includes the steps of forming a mixed waste from the solid waste with biological waste; and composting the mixed waste. The step composting of the mixed waste includes adding two composting accelerants. The first composting accelerant in the depicted method includes a first bacterial culture having one or more bacterial strains selected for an ability to break down starch and cellulose present in the waste. The second composting accelerant in the depicted method includes a second bacterial culture having one or more bacterial strains selected for an ability to break down hydrocarbons present in the waste. Both accelerants are sprayed or misted onto an upper surface of the mixed waste.

Apparatuses for use in this embodiment of the invention are now described.

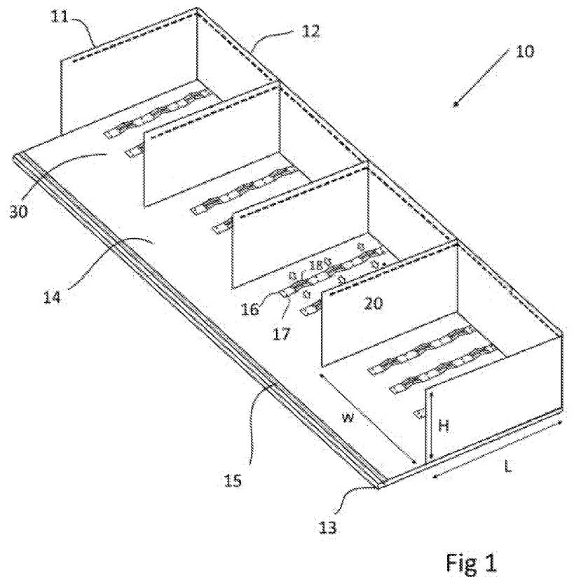

Referring to FIG. 1, a composting facility 10 is composed of four composting bays 30 formed by rear wall 12 and sidewalls 11. Each composting bay 30 has a width W and length L of about 5 m, and height H of the rear wall 12 and sidewalls 11 is about 1.5 m. The mechanically processed waste from the auger mixer 204 is typically placed into a particular bay until that bay is full, and thereafter a neighbouring bay is used, enabling a series of bays in different states of decomposition.

Each composting bay 30 is provided with aeration from below exiting from air channels through folded metal apertures 18 in three 10 mm thick steel air supply channel covers secured by bolts 16 and 17 into concrete pad 13. The steel air supply channel covers serve to cover three air supply channels of length approximately 4 m, to be described in more detail below.

Concrete pad 13 also comprises an access lane 14 of about 1 m width to allow access by the forklift in placing the mechanically processed waste and extracting composted final product.

Concrete pad 13 is slightly inclined towards spoon drain 15 which collects run-off water from the composting material.

Composting bay 30 is further provided with spray or misting applicators 20 in the sidewalls 11 or rear wall 12 for application of one or more composting accelerants through spray or misting applicator supply lines 21 to be described in more detail below.

Typically, the aeration system is operated continuously but may be varied in litres per hour according to environmental conditions. Typically, the composting accelerant application through spray or misting applicators 20 is performed at least once daily, applying a volume of water which may be augmented with additional accelerant ingredients such as bacteria and/or enzymes to be described below. Again, the litres per hour of water application or dosing of the accelerant may be adjusted depending on environmental conditions.

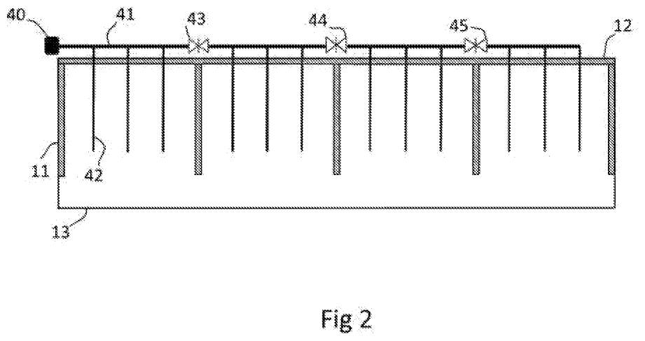

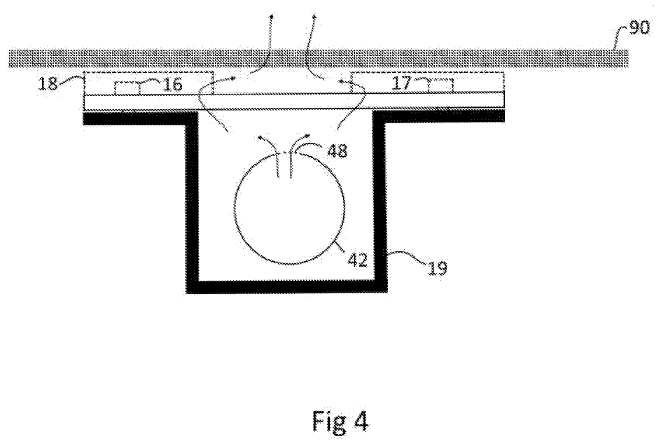

Referring now to FIGS. 2 and 4, details of the aeration system are provided. Air blower 40 blows air through air supply trunk line 41 which feeds three air supply pipes 42 in each bay. Shut-off valves 43, 44, 45 are operated manually or by a control system so that air can be provided to one, two, three or four bays depending on occupancy. Each air supply pipe 42 has 12 air holes 48 spaced along its length and extends the 4 m length of each corresponding 50 mm×50 mm cross-section air supply channel 19. The arrows shown in FIG. 4 shows the passage of air through the supply holes 48 and out of the channel through the folded metal apertures 18. Above the concrete floor and air channel cover plates is disposed a nylon mesh screen 90 which prevents particles of waste from blocking the air supply.

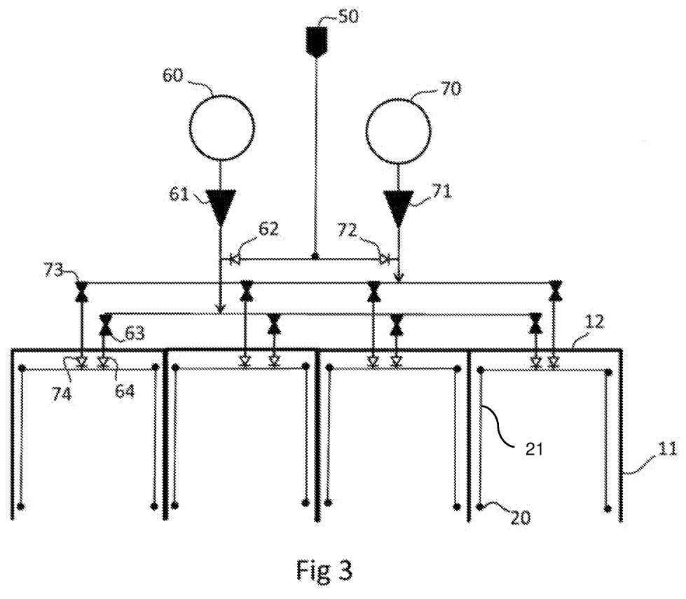

Referring now to FIG. 3, details of a composting accelerant dosing system are described. A water supply 50 mixes through nonreturn valves 62 and 72 with bacterial culture and/or enzymes as described above provided from first and second additive tanks 60 and 70 through dosing units 61 and 71. Additive tank 60 may comprise the first bacterial culture described above, and additive tank 70 may contain the second bacterial culture described above. The two separate accelerant dosed water streams pass through a corresponding separate sets of stop valves 63 and 73 and nonreturn valves 64 and 74 into mist or spray applicator supply lines 21 described above in each bay 30. The stop valve sets 63 and 73 can be differentially operated to differentially spray or mist each bay 30 depending on requirements. The nonreturn valves 62, 72, 64, 74 are provided to prevent contamination by mixing of different bacterial types within the supply lines. Water without the bacterial or enzymatic accelerants may also be applied to the compost, simply in order to maintain moisture balance or temperature.

The aeration system and composting accelerant dosing system is operated by a programmable control system which is able to be adjusted by an operator depending on changing conditions and requirements of the composting material and environmental conditions such as ambient temperature, humidity, and rainfall in the case of a facility in the open air.

It is believed that by mixing the solid waste from the cardboard manufacturing plant with the biological waste, improved aeration is provided thereby guaranteeing the supply of sufficient oxygen for healthy survival and growth of the bacteria, at the same time as providing a simple food source for the bacteria and/or provides heat thereby allowing the population of the bacteria to grow quickly to break down the much more complex compounds of starch, cellulose and hydrocarbons in the solid waste.

Other benefits are understood to result from the proposed invention, in one or more embodiments, including: protection against growing waste disposal costs; improvement in environmental footprint; a potential revenue stream; and a high likelihood of recouping set-up costs over the short-term.

Persons skilled in the art will appreciate that many variations may be made to the invention without departing from the scope of the invention, which is determined from the broadest scope and claims.

For example, while the embodiment described involves mixing of the green waste at two points in the process, mixing at a single point is within the broadest scope of the invention.

Further, while the embodiment described involves accelerants including bacteria and/or enzymes, the broadest scope of the invention extends to composting without other bacteria or enzyme accelerants besides those specifically mentioned in the specification, but which would be known to the skilled addressee to perform the required function as set out herein.

Further also, while the embodiment described involves the biological waste being green waste composed of woodchips, grass and leaves typically provided from residential green waste collection, the biological waste can be any compostable material compatible with a particular implementation, including sawdust, agricultural waste, manure, and other animal waste.

### Interpretation

### EMBODIMENTS

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

Similarly it should be appreciated that in the above description of example embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description of Specific Embodiments are hereby expressly incorporated into this Detailed Description of Specific Embodiments, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

### Different Instances of Objects

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

### Specific Details

In the description provided herein, numerous specific details are set forth. However, it is understood that embodiments of the invention may be practiced without these specific details. In other instances, well-known methods, structures and techniques have not been shown in detail in order not to obscure an understanding of this description.

### Terminology

In describing the preferred embodiment of the invention illustrated in the drawings, specific terminology will be resorted to for the sake of clarity. However, the invention is not intended to be limited to the specific terms so selected, and it is to be understood that each specific term includes all technical equivalents which operate in a similar manner to accomplish a similar technical purpose. Terms such as “upper”, “lower”, “forward”, “rearward”, “radially”, “peripherally”, “upwardly”, “downwardly”, and the like are used as words of convenience to provide reference points and are not to be construed as limiting terms.

The terms in the claims have the broadest scope of meaning they would have been given by a person of ordinary skill in the art as of the relevant date.

The terms “a” and “an” mean “one or more”, unless expressly specified otherwise

Neither the title nor any abstract of the present application should be taken as limiting in any way the scope of the claimed invention

Where the preamble of a claim recites a purpose, benefit or possible use of the claimed invention, it does not limit the claimed invention to having only that purpose, benefit or possible use.

In the present specification, terms such as “part”, “component”, “means”, “section”, or “portion” may refer to singular or plural items and are terms intended to refer to a set of properties, functions or characteristics performed by one or more items having one or more parts. It is envisaged that where a “part”, “component”, “means”, “section”, “portion”, or similar term is described as consisting of a single item, then a functionally equivalent object consisting of multiple items is considered to fall within the scope of the term; and similarly, where a “part”, “component”, “means”, “section”, “portion”, or similar term is described as consisting of multiple items, a functionally equivalent object consisting of a single item is considered to fall within the scope of the term. The intended interpretation of such terms described in this paragraph should apply unless the contrary is expressly stated or the context requires otherwise

The term “connected” or a similar term, should not be interpreted as being limitative to direct connections only. Thus, the scope of the expression an item A connected to an item B should not be limited to items or systems wherein an output of item A is directly connected to an input of item B. It means that there exists a path between an output of A and an input of B which may be a path including other items or means. “Connected”, or a similar term, may mean that two or more elements are either in direct physical or electrical contact, or that two or more elements are not in direct contact with each other yet still co-operate or interact with each other.

### Scope of Invention

Thus, while there has been described what are believed to be the preferred embodiments of the invention, those skilled in the art will recognize that other and further modifications may be made thereto without departing from the spirit of the invention, and it is intended to claim all such changes and modifications as fall within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

Although the invention has been described with reference to specific examples, it will be appreciated by those skilled in the art that the invention may be embodied in many other forms.

### Comprising and Including

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention. Further, any method steps recited in the claims are not necessarily intended to be performed temporally in the sequence written, or to be performed without pause once started, unless the context requires it.

Any one of the terms: “including” or “which includes” or “that includes” as used herein is also an open term that also means including at least the elements/features that follow the term, but not excluding others. Thus, including is synonymous with and means comprising.

It is to be understood that, if any prior art publication is referred to herein, such reference does not constitute an admission that the publication forms a part of the common general knowledge in the art, in Australia or any other country.

### INDUSTRIAL APPLICABILITY

It is apparent from the above, that the arrangements described are applicable to industries, such as cardboard manufacturing, in which the treatment of solid waste deriving therefrom has commercial and practical implications.

1. A method of treating solid waste extracted from a liquid waste stream of a cardboard manufacturing and/or converting facility, comprising the steps of:
forming a mixed waste from the solid waste with biological waste; and
composting the mixed waste;
wherein the step of composting the mixed waste includes adding one or more composting accelerants.

2. The method of claim 1, wherein the one or more composting accelerants include a first and a second bacterial culture.

3. The method of claim 2, wherein the first bacterial culture includes one or more of, or any combination of Pseudomonas fluorescens, Pseudomonas putida, Pseudomonas sutzeri, Bacillus subtilis and Bacillus licheniformis.

4. The method of claim 2, wherein the second bacterial culture includes one or more of, or any combination of Arthrobacter globiformis, Serratia plymuthica, Candida rugosa and Thiobacillus thioparus.

5. The method of claim 2, wherein the adding one or more composting accelerants includes providing a separate accelerant dosed streams for each of the first bacterial culture and the second bacterial culture, the two separate accelerant dosed streams passing through a corresponding separate set of two or more fluid lines.

6. The method of claim 5, wherein each accelerant dosed stream provides for separately mixing each accelerant with water.

7. The method of claim 1, wherein the adding of one or more composting accelerants includes adding by misting or spraying.

8. The method of claim 7, where the misting or spraying is to an upper surface of the mixed waste.

9. The method of claim 1, wherein the step of composting includes aerating the mixed waste by pumping air from beneath the mixed waste.

10. The method of claim 9, wherein the aerating of the mixed waste includes pumping air through an air supply channel located beneath the mixed waste.

11. The method of claim 9, wherein the aerating of the mixed waste includes pumping air through the air supply channel and/or an air supply cover, the air supply channel and/or cover comprising a plurality of raised and lowered portions.

12. (canceled)

13. (canceled)

14. The method of claim 1, wherein the step of composting includes forming the mixed waste into a pile and adding the one or more composting accelerants to the pile periodically.

15. The method of claim 1, further comprising the step of collecting run-off fluid from the step of composting and introducing the run-off fluid into a liquid waste stream of the cardboard manufacturing and/or converting facility.

16. The method of claim 1, wherein the step of forming a mixed waste comprises the step of depositing solid waste into a mixing apparatus and mechanically breaking up and mixing the solid waste with an initial proportion of the biological waste to form a mechanically processed waste.

17. The method of claim 16, wherein the step of forming a mixed waste comprises the step of depositing an additional proportion of the biological waste into the mixing apparatus in layers with the mechanically processed waste.

18. The method of claim 16, wherein the initial proportion of the biological waste is between 10% and 30% by volume of the mechanically processed waste.

19. The method of claim 17, wherein the additional proportion of the biological waste is between 10% and 25% of the mixed waste by volume.

20. The method of claim 16, wherein the biological waste in total is between 20% and 50% of the mixed waste by volume before the step of composting.

21. The method of claim 1, wherein the biological waste is a green waste.

22. The method of claim 21, wherein the green waste is composed of any one or more of wood chips, grass and leaves.

23. An apparatus for treating solid waste extracted from a liquid waste stream of a cardboard manufacturing and/or converting facility, the apparatus comprising:
a mixing system to mix the solid waste with biological waste to form a mixed waste;
one or more composting bays to contain one or more corresponding piles of the mixed waste;
and aeration system to aerate each of the one or more composting bays from below; and
a dosing system to dose one or more types of accelerant onto the composting mixed waste.

24. The apparatus of claim 23, wherein the aeration system is configured to pump air through an air supply channel located beneath the mixed waste and/or an air supply cover, and the air supply channel and/or cover comprise a plurality of raised and lowered portions.
